(19) United States
(12) Patent Application Publication
(10) Pub. No.: US 2003/0052626 A1
(43) Pub. Date: Mar. 20, 2003

(54) Electromotive drive unit

(75) Inventors: Klaus Wehmeyer, Herford (DE); Thomas Schroder, Melle (DE); Thomas Viermann, Lohne (DE); Ralf Bokamper, Lubbecke (DE)

Correspondence Address: HENRY M FEIEREISEN, 350 FIFTH AVENUE, SUITE 3220, NEW YORK, NY, 10118, US

(73) Assignee: DEWERT ANTRIEBS- UND SYSTEMTECHNIK GMBH & CO. KG, Kirchlengern (DE)

(21) Appl. No.: 10/246,789

(22) Filed: Sep. 17, 2002

Related U.S. Application Data
(63) Continuation of application No. PCT/EP01/03150, filed on Mar. 20, 2001.

(30) Foreign Application Priority Data
Mar. 20, 2000 (DE) 200 05 049.4

(51) Int. Cl. H02P 5/46

(52) U.S. Cl. 318/85

(57) ABSTRACT

An electromotive drive unit for an adjustable structure, for example a tabletop of a piece of furniture, includes at least one drive motor for adjusting a position of a structure. The drive motor includes a measuring unit for direct or indirect measurement of drive-specific parameters. A control unit is provided for controlling operation of the drive motor, and is acted upon by an evaluation unit for intervention in the adjustment process for the structure, when an actual value of the drive-specific parameters deviates from a desired value.

### CROSS-REFERENCES TO RELATED APPLICATIONS

This application is a continuation of prior filed copending PCT International application no. PCT/EP01/03150, filed Mar. 20, 2001.

This application claims the priority of German Patent Application Serial No. 200 05 049.4, filed Mar. 20, 2000, pursuant to 35 U.S.C. 119(a)-(d), the subject matter of which is incorporated herein by reference.

### BACKGROUND OF THE INVENTION

The present invention relates, in general, to an electromotive drive unit for at least one adjustable structure, for example, a tabletop of a piece of furniture, and more particularly to an electromotive drive unit of a type having a drive motor, whose operation can be controlled by a control unit.

An electromotive drive unit of the type involved here is preferably a linear drive or a rotary drive for adjustment of movable components of a furniture item. When constructed as linear drive, the electromotive drive unit may be used, i.a. also as height adjustment of a tabletop. Structures to be adjustable are under load of objects such as, e.g., a PC, office equipments, files, or the like. Adjustment is desired to suit, e.g., the height of a tabletop to different persons working at the worktable. The power output of the drive motor is dimensioned to cope with the maximal load of the structure to be adjusted. In some cases, it may be suitable to provide two or more motors for adjusting the structure, e.g. the tabletop.

During height adjustment of the tabletop, it is inevitable, especially during a lifting operation, that the tabletop moves against a fixed object which acts as a stop member. As a consequence, not only the object as well as the tabletop may be damaged but also components of the electromotive drive, e.g., windings of the drive motor, because in such a case, the current intensity of the electric motor circuit jumps suddenly and substantially. Although the drive motor will emit a respective sound, the operator may not necessarily become aware of this sound in view of relatively loud ambient noise generated in an office or other work environments.

Another consideration of electromotive drives involved here is the provision of a soft start and stop characteristic during adjustment of the table, whereby all intermediate movement patterns should be executed independently from the load. Lift travel is limited by mechanical stops, or limit switches provided internally in the drive and/or externally, or also additional freely programmable electronic overtravel switches. It is further suitable in connection with the use of such a furniture item, e.g., for persons of different size, to allow setting to the respective work heights (memory function) and execution of the required adjustments in a simple manner, even when the so-called reference points have been lost.

It would be desirable and advantageous to provide an improved electromotive drive unit which is constructed to prevent in a simple and cost-efficient manner an overload of the drive motor, which could possibly lead to a standstill.

### SUMMARY OF THE INVENTION

According to one aspect of the present invention, an electromotive drive unit for an adjustable structure, for example a tabletop of a piece of furniture, includes at least one drive motor for adjusting a position of a structure, with the drive motor including a measuring unit for direct or indirect measurement of drive-specific parameters; a control unit for controlling operation of the drive motor; and an evaluation unit operatively connected to the control unit for intervening in the adjustment process for the structure, when an actual value of the drive-specific parameters deviates from a desired value.

It is generally known that, e.g., the current intensity is significantly higher during the start-up phase of the motor than during subsequent running operation. This phase can be disregarded. During upward movement of, e.g., a tabletop, the current intensity remains constant or fluctuates at most only within a narrow range. When the tabletop hits, for example, a fixed object, or an object that can be moved only under exertion of a great force, the current intensity jumps suddenly and significantly. The evaluation unit compares the current intensity during normal operation with the actual current intensity, and intervenes, without comparison, in the adjustment process when a certain ratio or a predetermined current intensity is exceeded, so that the overload of the drive motor is immediately eliminated as soon as the current intensity rises. In order to allow intervention into the adjustment process, the jump in current intensity should be substantial because there are situations in which an additional load may be placed onto the tabletop during an adjustment movement, which, however, would not cause an overload of the drive motor. In such a case, intervention into the adjustment process is not desired.

According to another feature of the present invention, the evaluation unit may include a memory function, soft start and stop characteristic, and freely programmable limit switch function. In this way, any person working at the furniture item may at all times adjust the item to the same position. The soft start and stop characteristic results in a smooth initial movement and smooth stoppage during the adjustment operation, while the provision of freely programmable limit switches allows easy modification of the end positions at any time. These added functions of the evaluation unit can be implemented in an easy manner and enhance the operating comfort.

The current intensity for the drive motor may be ascertained directly in the current feed by means of a respective measuring device. Of course, an indirect measurement is also conceivable by measuring the rotation speed of the rotor of the drive motor or rotation of an attached rotatably driven component, because the speed decreases as the current intensity in a current feed increases. Thus, intervention in the adjustment process is dictated, when the rotation speed of the rotor or of the rotating structure falls below a predetermined rotation speed. In such a case, a given normal rotation speed corresponds to the common current intensity in the current feed for the motor. When the rotation speed drops below a certain level, the current intensity rises accordingly, so as to trigger an adjustment. The measurement of the rotation speed of the rotor of the drive motor has the advantage of a particular high accuracy of the measurement as the rotor of the drive motor normally runs at highest rotation speed in a drive unit. Typically the drive motor is operatively connected to a speed reducing gear mechanism so that respectively driven spindles rotate at significantly smaller rotation speed than the rotor of the motor.

Measurement of the rotation speed of the rotor of the drive motor or of an attached structure is suitably realized through current impulses. In this case, the drive unit is so configured that a revolution of the rotor or of the attached structure generates one or more impulses. In order to allow intervention into the adjustment process as a result of a change in current intensity or rotation speed, the current intensity or rotation speed are adjustable in increments for implementing the adjustment process.

When the electromotive drive unit according to the present invention is used in particular for height adjustment of a tabletop of a worktable, it may be suitable to provide the drive unit with at least two drive motors running in synchronism. An appropriate, generally known, synchronizing device is hereby required. When the electromotive drive according to the present invention is used in connection with a worktable, it is further advantageous to provide the drive unit with a further drive motor for implementing additional adjustment operations, e.g. inclination of the tabletop of the worktable. When encountering an obstacle, correction of a resultant excessive rise in the current intensity or excessive drop in the rotation speed, can be realized by configuring the drive motor as a motor that allows a reversal of the rotation direction, so that the drive motor reverses the rotation direction, when the predetermined current intensity is exceeded or the rotation speed falls below a predetermined level. The drive motor can then be shutdown after a given time. Of course, it may also be possible, to move the structure being adjusted to a predetermined base or idle disposition. In order to provide the user with information about the reason for a stoppage or interruption of the adjustment operation, it may be suitable to provide the drive unit with a trouble indicator which may be of optic or acoustic nature. Currently preferred is, however, the integration of such a trouble indicator within a hand switch used for controlling the drive unit.

The synchronous control for at least two drive motors or, in simplified embodiment for at least one drive motor, enables implementation of the functions memory, soft start and stop, and freely programmable limit switches.

In order to prevent a loss of stored data, regardless of the cause involved, the control unit may be so configured as to periodically check for a fixed reference point. This “reference check” may be triggered manually, e.g., after a power outage or during break-in. In any event, the reference check should be executed at reduced speed because the reference point may be a mechanical stop member.

According to another feature of the present invention, the evaluation unit may include a memory for storing drive-specific parameters, suitably in the form of a curve. The memory allows a later change of the curve or parameter. Moreover, the electromotive drive unit can be used in a simple manner for adjustment of different structures, without necessitating a particular configuration.

According to another feature of the present invention, the memory of the evaluation may have stored therein at least two, preferably three, operational modes of the drive unit and at least a parameter commensurate with an ambient temperature, wherein an image of individual parameters is applicable in dependence on a path traveled by a drive component or on an adjustment angle of the structure. The operating modes of the drive include, e.g., parameters such as motor voltage, travel distance, motor temperature, measured directly during operation and not computed indirectly and then fed directly to the evaluation unit. Of course, data relating to forces or torques may be inputted as well. It may be further provided to measure the parameters during a test run of the drive together wit the attached structure in idle run, at mean and maximum load together with the ambient temperature and further marginal conditions, and to construct the evaluation unit such that its memory provides an image of the individual parameters in dependence on the traveled distance of the drive or adjustment angle of a furniture item.

According to another feature of the present invention, the actual values of the drive-specific parameters can be compared during operation with stored values in a respective position of a drive component. The comparative result in dependence on the position of the drive constitutes a decision criterion for the evaluation unit to intervene in an appropriate and targeted as well as adjusted manner into the control of the drive movement.

According to another feature of the present invention, the evaluation unit can be so configured as to include a wear of drive components through application of a training function into the copied image. Monitoring of the parameters is not restricted by motor break-in times but is immediately effective as soon as the drive unit is started. In addition, monitoring is not only effective during upward movement of a structure but also during downward movement over the entire travel path.

According to another feature of the present invention, the evaluation unit can be so configured as to trigger a shutdown of the drive motor, when a user ignores given instructions. In this way, improper use becomes impossible so that an incorrect handling will not result in damage of those components that are connected to the drive. Suitably, a signal may be provided to inform the user of such an incorrect handling. If the signal is ignored, the drive unit may be constructed to shutdown for the standard dead time interval. The distance measurement also allows a shutdown of the motor, when a defective limit switch is passed or the limit switch is non-responsive at the moment of passage, without requiring a current increase through movement against a mechanical stop with resultant possible damage. Also, certain reference points may be set along the travel path for a control and/or regulating task, such as, e.g., stoppage or changeover of another motor which runs simultaneously.

According to another feature of the present invention, the drive motor may be constructed to include a non-volatile memory chip for storage of drive-specific parameters. As a result, these data are retained during a power outage. The evaluation unit may then be able to read the content of the memory chip to optimally match motor, control and attached equipment.

According to another feature of the present invention, the drive motor may be constructed to include an oscillation-transmitting device for transmitting a structure-borne sound as electric signal to the evaluation unit. In this way, a comparison with previously stored data allows inference about the operating behavior of the motor and intervention in the control circuit. Conceivable is here also the use of a transmitter unit, which has integrated therein an oscillation-transmitting device and temperature-transmitting device, and like components.

It is already known to calculate certain changing values on the bases of certain parameters at certain times certain changing values which can be used as decision criterion for intervention in the motor control. It is also known to store speed values of the motor and to calculate with actual values certain threshold values in dependence on the position for certain areas of the travel path as prediction values which are then compared with further actual values to establish an intervention in the control circuit of the motor. A drawback hereby is their applicability only for adjustable components of vehicles, such as sun roofs or window openers and the like or other adjustment drives, but not for the various requirements in connection with furniture drives with particular lever operations and their characteristics, such as sluggishness in operation, great bearing plays, extreme starting forces, etc. Moreover, the use of furniture drives has to comply with different standards, i.a. in the nursing field or hospital field. For example, a furniture drive is more frequently in use than a window opener or a sun roof in a motor vehicle, especially since the operating elements are positioned in the area of the drive and the probability of a continuous actuation during travel is slim.

The high momentary currents of the motor during the start-up phase may be suppressed through suitable delay circuits. Experience has shown that this leads, however, to problems in many applications. The force/current pattern as a function of the distance, e.g. in conjunction with a reclining chair, is not linear but exhibits also other local maxima, resulting in a shutdown. This is, however, not caused by external blockage but a system-inherent feature. When adjusting the shutdown value in such a manner that these local maxima do not lead to a shutdown, intermediate current peaks caused by blockage or overload and lying below the local maximum value, will not trigger a shutdown. A further drawback of such systems is the possibility of faulty operations as a result of tolerances of the components at a critical adjustment of only one parameter, e.g., the motor current. These measures relate to momentary overloads of the motor and the participating components. As a result, prolonged overloads cannot be registered and proper use in compliance with official safety norms for the pertaining field of application cannot be satisfied. The present invention also allows a linkage of several drive units, as, e.g., required for control of beds.

An essential feature of the present invention is the capability to intervene in the adjustment process, when a sudden and significant jump in current intensity or a sudden and significant decrease in rotation speed is experienced.

### BRIEF DESCRIPTION OF THE DRAWING

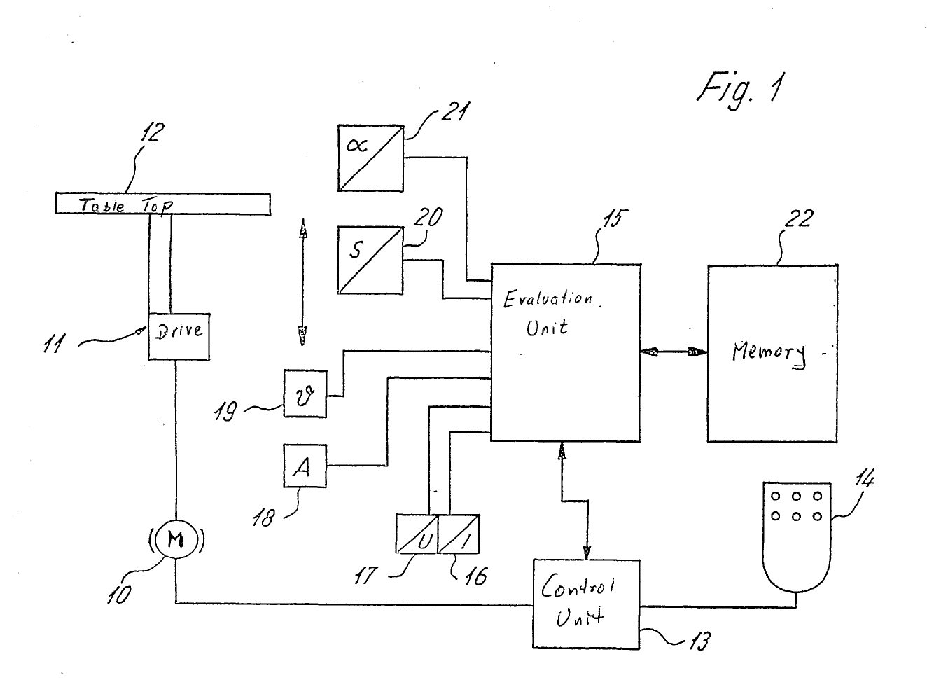

Other features and advantages of the present invention will be more readily apparent upon reading the following description of currently preferred exemplified embodiments of the invention with reference to the accompanying drawing, in which FIG. 1 is a block diagram showing the relationship and operation of components of an electromotive drive according to the present invention.

### DETAILED DESCRIPTION OF PREFERRED EMBODIMENTS

Turning now to FIG. 1, there is shown a block diagram showing the relationship and operation of components of an electromotive drive unit according to the present invention, which includes a motor 10 for operating a drive 11. In the non-limiting example of FIG. 1, the drive 11 implements a height adjustment of a tabletop 12. Operation of the motor 10 is controlled by a control unit 13 which is addressed by a handling device 14 in the form of a hand switch. The handling device 14 includes several actuating elements, e.g., push-button keys. Interacting with the control unit 13 is an evaluation unit 15 in which several drive-specific parameters are inputted, e.g., current intensity, voltage, a measured force, a measured temperature, a distance traveled, or an angle. These parameters are designated by reference numerals 16, 17, 18, 19, 20, 21. The evaluation unit 15 is further provided with a memory 22 which can be supplied with the values either in the form of curves or default values.

The mode of operation is as follows: A measuring device (not shown) ascertains the drive-specific parameters. For example, the measuring device determines the current intensity for the motor 10 in a current feed, as the tabletop 12 is adjusted in height. The measured level of the current intensity is transmitted to the evaluation unit 15 and compared with a predetermined value in the memory 22. When the measured value deviates from a predetermined value, e.g., when the tabletop 12 hits an obstacle, so that the current intensity jumps as the rotation speed of the rotor of the motor 10 decreases, the evaluation unit 15 intervenes in the adjustment process and instructs the control unit 13 to stop or interrupt the adjustment process by shutting down the motor 10 and consequently the drive 11. Thus, the motor 10 is protected against overload.

While the invention has been illustrated and described in connection with preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. An electromotive drive unit for an adjustable structure, for example a tabletop of a piece of furniture, comprising:
at least one drive motor for adjusting a position of a structure, said drive motor including a measuring unit for direct or indirect measurement of drive-specific parameters;
a control unit for controlling operation of the drive motor; and
an evaluation unit operatively connected to the control unit for intervening in the adjustment process for the structure, when an actual value of the drive-specific parameters deviates from a desired value.

2. The drive unit of claim 1, wherein the evaluation unit has a feature selected from the group consisting of memory function, soft start and stop characteristic, and freely programmable limit switch function.

3. The drive unit of claim 1, wherein the evaluation unit includes a memory for storing the drive-specific parameters.

4. The drive unit of claim 3, wherein the drive-specific parameters are inputted in the form of a curve.

5. The drive unit of claim 1, wherein the structure is rotatably driven, said measuring device ascertaining a rotation speed of a rotor of the drive motor or of the structure, wherein the evaluation unit instructs the control unit to intervene in the adjustment process as the rotation speed of the rotor or of the rotating structure falls below a predetermined rotation speed, accompanied by an increase of current intensity in a current feed.

6. The drive unit of claim 5, wherein the rotation speed of the rotor or of the rotating structure is convertible into countable current impulses.

7. The drive unit of claim 5, wherein the current intensity and the rotation speed are adjustable in increments for implementing the adjustment process.

8. The drive unit of claim 1, and further comprising a second said drive motor, wherein the drive motors operate in synchronism.

9. The drive unit of claim 1, and further comprising a further drive motor for implementing additional adjustment operations.

10. The drive unit of claim 5, wherein the drive motor is a motor with reversal of rotation direction, so that the drive motor reverses the rotation direction, when a predetermined current intensity is exceeded and the rotation speed falls below a predetermined level.

11. The drive unit of claim 10, wherein the drive motor runs in reverse rotation direction over a predetermined time or the attached structure travels into a predetermined basic position.

12. The drive unit of claim 17 wherein the control unit checks a fixed reference point in predetermined time intervals.

13. The drive unit of claim 12, wherein a checking of the fixed reference point in predetermined time intervals by the control unit is triggered by hand.

14. The drive unit of claim 12, wherein a checking of the fixed reference point in predetermined time intervals by the control unit is executed at reduced speed compared to a normal speed.

15. The drive unit of claim 3, wherein the memory of the evaluation has stored therein at least two operational modes of the drive unit and at least a parameter commensurate with an ambient temperature, wherein an image of individual parameters is applicable in dependence on a path traveled by a drive motor or on an adjustment angle of the structure.

16. The drive unit of claim 15, wherein the memory of the evaluation has stored therein three operational modes of the drive unit.

17. The drive unit of claim 1, wherein actual values of the drive-specific parameters are compared during operation with stored values in a respective position of a drive component.

18. The drive unit of claim 15, wherein the evaluation unit is so configured as to trigger a shutdown of the drive motor, when a user ignores given instructions.

19. The drive unit of claim 1, wherein the drive motor is constructed to include a non-volatile memory chip for storage of the drive-specific parameters

20. The drive unit of claim 1, wherein the drive motor is constructed to include an oscillation-transmitting device for transmitting a structure-borne sound as electric signal to the evaluation unit.
